(19) United States
(12) Patent Application Publication
(10) Pub. No.: US 2026/0173152 A1
(43) Pub. Date: Jun. 18, 2026

(54) RANDOM ACCESS METHODS FOR WIRELESS COMMUNICATION NETWORKS

(71) Applicant: Google LLC, MOUNTAIN VIEW, CA (US)

(72) Inventors: Ming-Hung TAO, Taoyuan City (TW); Chih-Hsiang WU, Taoyuan City (TW)

(21) Appl. No.: 19/124,814

(22) PCT Filed: Nov. 10, 2023
(86) PCT No.: PCT/US2023/037151

§ 371 Date: Apr. 25, 2025

Related U.S. Application Data
(60) Provisional application No. 63/383,480, filed on Nov. 11, 2022.

(51) Int. Cl. H04W 74/0833; H04W 74/00

(52) U.S. Cl. CPC H04W 74/0833; H04W 74/006

(57) ABSTRACT

Methods and devices modify a random access procedure in a wireless network to take into consideration not only a size of a given message that is necessary for the procedure, but also a size of additional information that a user equipment may need to provide at the time of the procedure. The modified random access procedure may also consider an operational state of the user equipment, the type of network cell (e.g., terrestrial or non-terrestrial) used for network access, and/or whether a flag is enabled to indicate the presence of the additional information.

### FIELD OF THE DISCLOSURE

This document relates to wireless communications and, more particularly, to random access methods performed by a user equipment (UE) and/or a network entity (NE) to establish wireless connection.

### BACKGROUND

This background description is provided for the purpose of generally presenting the context of the document. Work of the presently named inventors, to the extent it is described in this background section, as well as aspects of the description that may not otherwise qualify as prior art at the time of filing, are neither expressly nor impliedly admitted as prior art against the present document.

Generally, a base station (BS) operating a cellular radio access network (RAN) communicates with a UE using a certain radio access technology (RAT) and multiple layers of a protocol stack. For example, the physical layer (PHY) of a RAT provides transport channels to the medium access control (MAC) sublayer, which in turn provides logical channels to the radio link control (RLC) sublayer, and the RLC sublayer in turn provides data transfer services to the packet data convergence protocol (PDCP) sublayer. The radio resource control (RRC) sublayer is disposed above the PDCP sublayer.

The RRC sublayer specifies the following states: the RRC_IDLE state, in which a UE does not have an active radio connection with a BS and does not store a UE access stratum (AS) context; the RRC_CONNECTED state, in which the UE has an active radio connection with the BS; and the RRC_INACTIVE state for allowing the UE to more quickly transition back to the RRC_CONNECTED state due to RAN-level BS coordination and RAN-paging procedures. Depending on different implementations or scenarios, the BS can configure small data transmission (SDT) for the UE operating in the RRC_INACTIVE state to transmit one or more small packets.

The 5G technology relies primarily on legacy terrestrial networks (TN). However, the 3^{rd} Generation Partnership Project (3GPP) organization has proposed to extend 5G communications to non-terrestrial networks (NTNs) with 5G new radio (NR) technologies, or with the Long-Term-Evolution (LTE) technologies tailored for the narrowband internet-of-things (NB-IoT) or the enhanced machine type communication (eMTC) scenarios. In an NTN, a radio frequency (RF) transceiver is mounted on a satellite, an uncrewed aircraft system (UAS), also called drone, balloon, plane, or another suitable apparatus. For simplicity, the discussion below refers to each such apparatus as satellite. In addition to satellites, an NTN can include satellite gateways (sat-gateways) that connect the NTN to a public data network, feeder links between sat-gateways and satellites, service links between satellites and end-user equipment, and inter-satellite links (ISL) when the satellites form constellations.

A geosynchronous orbit (GSO) satellite can communicate with one or several sat-gateways deployed over a satellite targeted coverage area (e.g., a region or even a continent). A non-GSO satellite, at different times, may communicate with one or several serving sat-gateways. An NTN is designed to ensure service and feeder link continuity between successive serving sat-gateways, with sufficient time duration to proceed with mobility anchoring and hand-over.

A satellite can support a transparent or a regenerative (with on-board processing) payload, and typically generates several beams for a given service area bounded by the field of view. The footprints of the beams typically have an elliptic shape and depend on the on-board antenna configuration and the elevation angle. For a transparent payload implementation, a satellite can apply RF filtering and frequency conversion and amplification, and not change the waveform signal. For a regenerative payload implementation, a satellite can apply RF filtering, frequency conversion and amplification, demodulation and decoding, routing, and coding/modulation. This approach is effectively equivalent to implementing most of the functions of a BS, e.g., a gNB.

NB-IoT and eMTC technologies are expected to be particularly suitable for IoT devices operating in remote areas with limited or no terrestrial connectivity. Such IoT devices can be used in a variety of industries including, for example, transportation (maritime, road, rail, air) and logistics; solar, oil, and gas harvesting; utilities; farming; environmental monitoring; and mining. However, to ensure the required IoT connectivity, deployment of these technologies requires satellite connectivity to provide coverage beyond terrestrial deployments. Satellite NB-IoT or eMTC is defined in a complementary manner to terrestrial deployments.

Compared to the TN communication, the NTN communication has a very long latency caused by the service link (i.e., the link between the UE and satellite) and feeder link (i.e., the link between the satellite and BS). When the UE in an idle state (e.g., the UE operates in the RRC_IDLE state without a UE AS context) initiates data transmission in an NTN, the UE has to perform several procedures with a BS and a core network to communicate application data with an application server. These procedures can include a service request procedure, RRC connection establishment procedure, non-access stratum (NAS) authentication procedure, NAS security command procedure, RRC security command procedure, RRC reconfiguration procedures, etc. Messages are exchanged between the UE and BS or core network, which consumes significant time.

When the BS detects data inactivity for the UE operating in the RRC_CONNECTED state, the BS can suspend the active radio connection with the UE by transitioning the UE to the RRC_INACTIVE state or transitioning the UE to the RRC_IDLE state with a suspended RRC connection (i.e., the UE in the RRC_IDLE state stores a UE AS context). When the UE has application data to send, the UE can perform an RRC connection resume procedure (i.e., a single RRC procedure) with the BS to resume the suspended active radio connection and transition to the RRC CONNECTED state. The UE is then able to immediately communicate the application data, upon completing the RRC connection resume procedure.

When the UE in the RRC_INACTIVE state or the RRC_IDLE state with a suspended radio connection initiates an RRC connection resume procedure for UL (uplink) data transmission or periodic RAN notification area (RNA) update, the UE starts a timer (e.g., T319 or T300). If the UE successfully completes the RRC connection resume procedure with the BS, the UE stops the timer. However, if the timer expires because the UE fails the RRC connection resume procedure, the UE releases the UE AS context and transitions to the RRC_IDLE state.

In an NTN, as a satellite moves on a specified orbit, for example in case of a NGSO satellite, the satellite beam(s) coverage area may move and cover different portions of a geographical area due to the orbital movement of the satellite. As a consequence, the UE located in the concerned geographical area may experience a situation of discontinuous coverage, due to e.g., a sparse satellite constellation deployment. In such a situation, the UE in the NTN can lose coverage for a long time period (e.g., tens of minutes to hours) due to the discontinuous coverage. In some cases, the UE in the NTN might initiate the RRC connection resume procedure while the UE is out of coverage, due to the time-discontinuous coverage. The RRC connection resume procedure triggers a cell search, which is initiated by a random access procedure. The random access procedure includes, inter alia, exchanging various information between the UE and the BS.

Coordination or lack of coordination between the exchanged information may lead to the UE repeatedly performing the random access procedure. Thus, the cell search associated with the random access procedure may waste the UE's battery power. Moreover, for some situations, the above noted timer expires because the UE fails the RRC connection resume procedures. Upon expiry of the timer, the UE releases the UE AS context and transitions to the RRC_IDLE state, which will cause a long delay in transmitting data the next time the UE tries to establish a connection with the BS, because the UE needs now to perform several additional procedures.

Another problem experienced by the existing networks is related to the transmission of data during the random access procedure. To accommodate transmission of data with different sizes from a UE to the BS, during a random access procedure, the BS broadcasts configuration parameters to be used by the UE during the random access procedure. The configuration parameters include random access preambles group A (simply called “group A” in this document) and random access preambles group B (simply called “group B” in this document), and each such group includes corresponding one or more random access preambles. A random access preamble is a short sequence of bits or symbols transmitted by the UE to initiate a random access procedure when it wants to establish a connection with the BS. The primary function of a random access preamble is to notify the BS of the UE's presence and request resources to complete a specific task, such as establishing a connection to the network. The BS needs to detect the preamble to identify the UE and allocate resources for such communication.

Random access preambles are divided into two groups, i.e., group A and group B. The random access preambles in groups A and B are different. The UE uses a preamble in group A when sending a packet with a size smaller than or equal to a preset size and uses a preamble in a group B when sending a packet with a size larger than the preset size. For example, the preset size is 56 bits, but other values may be used. The BS broadcasts a size configuration (including the preset size) to the UE so that the UE can select a group A or group B preamble.

When the UE initiates transmission of a common control channel (CCCH) service data unit (SDU) (i.e., a CCCH message), the UE selects either group A or group B preambles based on a size of the CCCH SDU, as described in 3GPP technical specification (TS) 38.321 or 36.321, depending on which radio access technology is used by the UE. The UE initiates the CCCH transmission when the UE is first powered on or enters a cell coverage area, and it needs to establish a connection with the network, TN or NTN. The CCCH message can be, for example, an RRC setup request, RRC resume request, or RRC reestablishment request message. If the size of the CCCH SDU is smaller than or equal to the preset size, the UE selects group A preambles. Otherwise, if the size of the CCCH SDU is larger than the preset size, the UE selects group B preambles.

The UE randomly selects a random access preamble from the selected random access preambles group (i.e., group A or group B) and transmits the random access preamble to the BS. When implementing a two-step random access procedure, after (e.g., in response to) receiving the random access preamble from the UE, the BS transmits a random access response (RAR) to the UE. If the received random access preamble belongs to group A, the BS generates a first UL grant (i.e., random access response (RAR) grant) for a UL transmission with the preset size and includes the first UL grant in the RAR. If the received random access preamble belongs to group B, the BS generates a second UL grant (i.e., RAR grant) for a UL transmission, with a size larger than the preset size, and includes the second UL grant in the RAR.

In some cases, the UE has additional information, such as a MAC control element (MAC CE), control-plane data (e.g., a NAS message), and/or user-plane data (e.g., a small data transmission packet), to transmit together with the CCCH message. Because the UE uses only the size of the CCCH message to select the group A or group B, there are situations when the size of the additional information would not fit into the selected preamble. This is so because the UE does not factor in the size of the additional information when selecting the random access preambles group. For these situations, when the UE receives from the BS the RAR including the first UL grant, the UE cannot include the additional information together with the CCCH message in a MAC protocol data unit (PDU) due the fact that the UL grant does not configure sufficient space in the MAC PDU. Thus, for these cases, the UE only includes the CCCH message in the MAC PDU and transmits the MAC PDU to the BS as a message 3 (Msg3, which is part of a four-step random access procedure). Thus, the BS cannot receive the additional information together with the CCCH message from the UE, which causes inefficiency in communication with the UE.

Note that message 3 is part of the four-step random access procedure and this procedure includes: a message 1 sent by the UE and related to the preamble transmission, in which the UE selects the random access preamble; a message 2, related to the RAR, when the BS sends to the UE a response with various configuration factors, including the timing advance (TA) for timing adjustment between the uplink and downlink transmission, and also the first UL grant discussed above; the message 3, which is transmitted using the first UL grant resources, and may carry a certain RRC message or data; and message 4, related to contention resolution, and includes the UE identity, confirming that the BS has correctly identified the UE and the contention has been resolved.

Sending the CCCH message to the BS and later exchanging the TA also happens to the UE when selecting a cell of the BS via a satellite in an NTN. For this scenario, the UE initiates an RRC procedure and performs a TA reporting during the RRC procedure. The UE initiates the TA reporting before transmitting the CCCH message of the RRC procedure. For example, the RRC procedure is an RRC connection resume procedure, and the CCCH message is an RRC resume request message as described in 3GPP TS 38.331.

In response to initiating transmission of a TA report, the UE initiates the random access procedure discussed above. The TA report is a MAC CE with 2 octets (i.e., 16 bits) and there is a MAC subheader (i.e., 8 bits) for the TA report MAC CE, as described in 3GPP TS 38.321 or 36.321. Because the total size of the TA report MAC CE and MAC subheader is 24 bits, which is less than the preset size, the UE selects a random access preamble from the group A. In response to initiating the random access procedure, the UE transmits the random access preamble to the BS. The BS transmits a RAR to the UE, including a UL grant for a UL transmission with the preset size. Upon receiving the RAR, the UE transmits the MAC subheader and the TA report MAC CE to the BS using the received UL grant. However, when the BS receives the TA report MAC CE, the BS cannot identify which UE is transmitting the TA report MAC CE because the BS has not received the CCCH message. Therefore, the BS discards the TA report, which is undesired. This inefficiency occurs in the existing networks due to a lack of coordination between (1) sending the TA report and the CCCH message and (2) initiating the random access procedure.

Thus, there are various instances when a UE loses connection or suspends itself from communicating with a NE of a RAN and then needs to connect or reconnect to a cell of the RAN. To resume connection, or reestablish the connection, or to establish a new connection, the UE may initiate a random access procedure, by sending to the NE, a random access preamble, which belongs to a certain random access preambles group. When there are plural random access preambles groups, each group is associated with a corresponding message having an allowed size. Conventionally, the UE selects a random access preamble group based exclusively on a size of a CCCH message and an associated subheader, to be sent to the NE. When the random access procedure is initiated, if the UE needs to send, in addition to the CCCH message, information that has a size larger than an allowed size associated with the selected random access preambles group, the UE needs to perform multiple uplink transmissions to transmit all the information.

If the UE communicates via an NTN cell, it is more likely that the UE needs to communicate more information than the CCCH message, at the time of the random access procedure, compared to communicating via a TN cell.

### SUMMARY OF THE INVENTION

During a random access procedure, a UE sends a random access preamble to request the NE to allocate uplink resources enabling the UE to transmit messages. A random access preambles group, to which the random access preamble belongs, indicates the amount of UE-requested uplink resources. When the UE has additional information to send to the NE during the random access procedure, besides a CCCH message, a random access preambles group selected based only on the size of the CCCH message may prevent the UE from sending the additional information together with the CCCH message. When the UE selects the random access preambles group based on a compounded size of the CCCH message and the additional information (with respective headers as needed), the NE is now requested to allocate increased resources, enabling the UE to transmit the CCCH and the additional information at the same time. In this manner, the UE saves resources and power relative to the conventional approach.

In one variation of the above procedure, the UE may consider, when selecting the random access preambles group, whether the UE operates in an idle state, inactive state, or a connected state with a failure timer running. In another variation, the UE waits to receive the additional information and only then initiates the random access procedure or selects the random access preambles group. In yet another variation, the NE determines whether the UE intends to reconnect via a TN cell or an NTN cell, and based on this determination, the NE transmits an appropriately-sized uplink (UL) grant to the UE. The NE may also consider whether the additional information, e.g., a TA report, is expected to be received, before selecting the appropriately-sized UL grant. In still another variation, the NE decides to perform a two- or four-step random access procedure and adjusts the steps discussed above based on the selected procedure. In yet another variation, the NE sends a UL grant that allows a larger message size transmission from the UE than the message size associated with the received random access preamble.

### BRIEF DESCRIPTION OF THE DRAWINGS

FIG. 1 is a block diagram of an example wireless communication system in which a UE and a BS, or other type of network entity (NE), can implement the various random access procedures of this document;

FIG. 2 is a block diagram of an example BS having a centralized unit (CU) and a distributed unit (DU) that can operate in the system of FIG. 1;

FIG. 3A is a block diagram of an example NTN node with transparent payload implementation;

FIG. 3B is a block diagram of an example NTN node with transparent payload implementation, in which a BS connects to multiple satellites via the same satellite gateway;

FIG. 4 is a block diagram illustrating structural elements of a UE and a BS configured to perform methods for random access according to an embodiment.

FIGS. 5A-5C illustrate various random access scenarios for UE and NE operating according to other embodiments.

FIG. 6 depicts a flow diagram illustrating a first random access method performed by the UE according to various embodiments.

FIGS. 7A and 7B depict flow diagrams illustrating second random access methods performed by the UE RRC entity according to various embodiments.

FIG. 8 depicts a flow diagram illustrating a third random access method performed by the UE in a non-connected state according to various embodiments.

FIG. 9 depicts a flow diagram illustrating a fourth random access method in which the UE considers whether additional information needs to be transmitted, according to various embodiments.

FIG. 10 depicts a flow diagram illustrating a fifth random access method in which the UE verifies whether a compounded size of a message is larger than a preset size, according to various embodiments.

FIGS. 11A to 11D depict flow diagrams illustrating sixth random access methods in which the NE determines whether an NTN cell is used and/or a TA report flag is enabled, according to various embodiments.

FIG. 12 depicts a flow diagram illustrating a seventh, random access method performed by the NE according to various embodiments involving a four-step random access procedure.

FIGS. 13A and 13B depict flow diagrams illustrating an eighth random access method performed by the NE according to various embodiments based on various conditions.

FIG. 14 depicts a flow diagram illustrating a ninth random access method performed by the NE according to various embodiments involving a two-step random access procedure.

FIG. 15 depicts a flow diagram illustrating a tenth random access method performed by an RRC layer of the UE according to various embodiments.

FIG. 16 depicts a flow diagram illustrating an eleventh random access method in which the UE receives an uplink grant according to various embodiments.

### DETAILED DESCRIPTION OF THE DRAWINGS

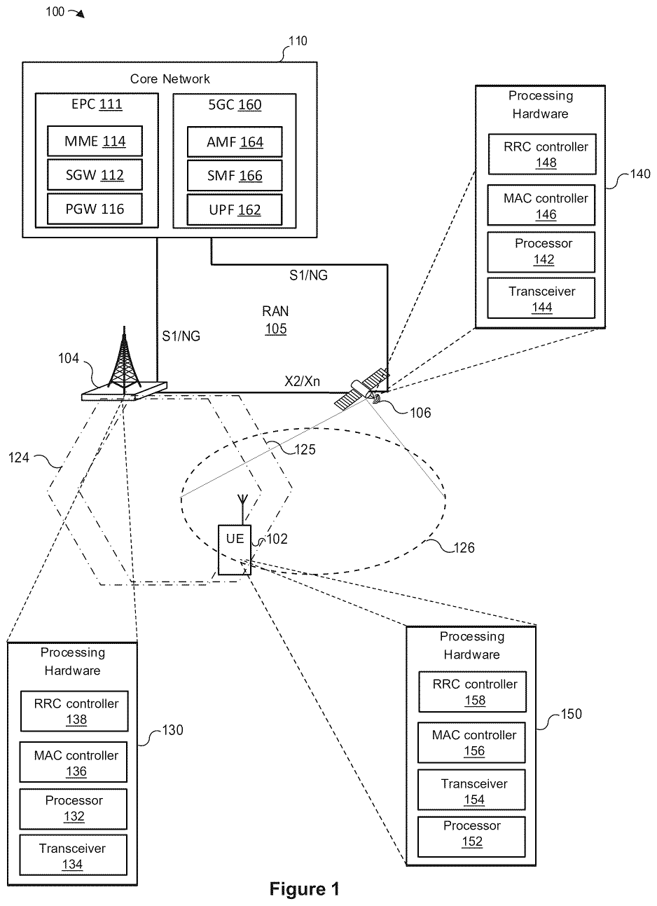

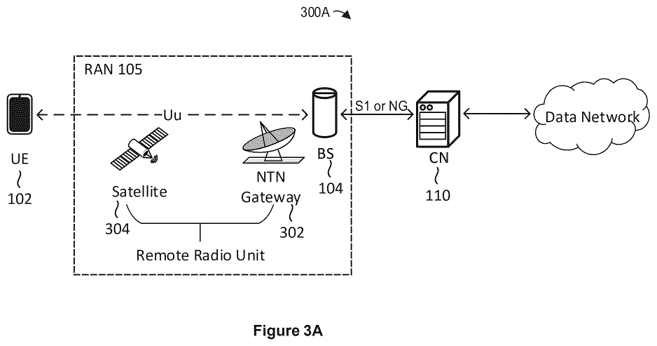

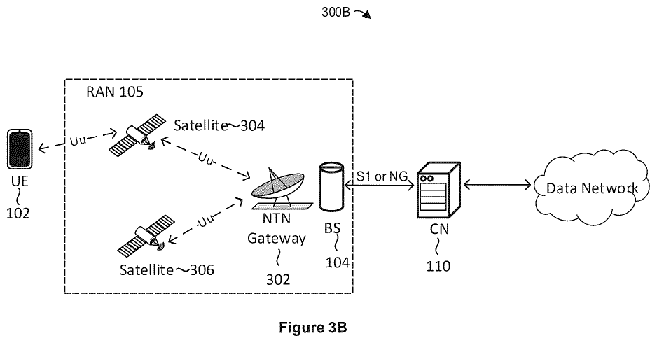

Referring to FIG. 1, an example wireless communication system 100 includes a UE 102, a first BS 104, a second BS 106 that may communicate with UE 102 via satellite (therefore second BS 106 is represented in this figure as a satellite icon but its setup is illustrated in more detail in FIGS. 3A and 3B), and a core network (CN) 110.

The second BS 106 may also communicate via a TN and the first BS 104 may communicate via an NTN. The BSs 104 and 106 can operate in a RAN 105 connected to the CN 110. The CN 110 can be implemented, for example, as an evolved packet core (EPC) 111 or a 5G core (5GC) 160. The CN 110 can also be implemented as a sixth generation (6G) core in another example.

The first BS 104 covers two cells 124 and 125 (in this example, but can cover any number of cells), and the BS 106 covers a cell 126 (for example, an NTN cell). If the first BS 104 is a gNB, the cells 124 and 125 are NR cells. If the first BS 104 is an ng-eNB or eNB, the cells 124 and 125 are evolved universal terrestrial radio access (E-UTRA) cells. The cells 124, 125, and 126 can be in the same RNAs or different RNAs.

The RAN 105 may include any number of BSs, and each BS can cover one, two, three, or any other suitable number of cells. The UE 102 can support at least a 5G NR (or simply, “NR”) or E-UTRA air interface to communicate with the BSs 104 and 106. Each of the BSs 104, 106 can connect to the CN 110 via an interface (e.g., S1 or NG interface). The BSs 104 and 106 also can be interconnected via an interface (e.g., X2 or Xn interface) for interconnecting NG RAN nodes.

Among other components, the EPC 111 can include a Serving Gateway (SGW) 112, a Mobility Management Entity (MME) 114, and a Packet Data Network Gateway (PGW) 116. The SGW 112 is configured to transfer user-plane packets related to audio calls, video calls, Internet traffic, etc., and the MME 114 is configured to manage authentication, registration, paging, and other related functions. The PGW 116 provides connectivity from the UE to one or more external packet data networks, e.g., an Internet network and/or an Internet Protocol (IP) Multimedia Subsystem (IMS) network. The 5GC 160 includes a User Plane Function (UPF) 162 and an Access and Mobility Management Function (AMF) 164, and/or Session Management Function (SMF) 166. Generally, the UPF 162 is configured to transfer user-plane packets related to audio calls, video calls, Internet traffic, etc., the AMF 164 is configured to manage authentication, registration, paging, and other related functions, and the SMF 166 is configured to manage PDU sessions.

As further illustrated in FIG. 1, the first BS 104 supports two TN cells 124 and 125, and the second BS 106 supports a cell 126 (can be NTN cell). The cells 124, 125, and 126 can partially overlap, so that the UE 102 can select, reselect, or hand over from one of the cells 124, 125, and 126 to the other. To directly exchange messages or information, the first BS 104 and second BS 106 can support an X2 or Xn interface. The CN 110 can connect to any suitable number of BSs supporting NR cells and/or EUTRA cells.

As discussed in detail below, the UE 102 and/or the RAN 105 may utilize the techniques of this document when establishing or reestablishing a radio connection between the UE 102 and the RAN 105 is desired, e.g., when the UE 102 operates in an inactive or idle state of the protocol for controlling radio resources between the UE 102 and the RAN 105. For clarity, the examples below refer to the RRC_INACTIVE or RRC_IDLE states of the RRC protocol.

The first BS 104 is equipped with processing hardware 130 that can include one or more general-purpose processors (e.g., CPUs) and a non-transitory computer-readable memory storing instructions that the one or more general-purpose processors execute. Additionally, or alternatively, the processing hardware 130 can include special-purpose processing units. The processing hardware 130, in an example implementation, includes a processor 132 to process data that the first BS 104 will transmit in the downlink direction, or process data received by the first BS 104 in the uplink direction. The processing hardware 130 can also include a transceiver 134 configured to transmit data in the downlink direction and to receive data in the uplink direction. The processing hardware further can include a MAC controller 136 to implement procedures and messaging at the MAC layer, and an RRC controller 138 to implement procedures and messaging at the RRC sublayer of the protocol communication stack. The second BS 106 can include generally similar components. In particular, components 140, 142, 144, 146, and 148 of the second BS 106 can be similar to the components 130, 132, 134, 136, and 138 of the first BS 104, respectively.

The UE 102 is equipped with processing hardware 150 that can include one or more general-purpose processors such as CPUs and non-transitory computer-readable memory storing machine-readable instructions executable on the one or more general-purpose processors, and/or special-purpose processing units. The processing hardware 150 in an example implementation includes a processor 152 to process data that the UE 102 will transmit in the uplink direction, or process data received by UE 102 in the downlink direction. The processing hardware 150 can also include a transceiver 154 configured to transmit data in the downlink direction and to receive data in the uplink direction. The processing hardware can further include a MAC controller 156 to implement procedures and messaging at the MAC layer, and an RRC controller 158 to implement procedures and messaging at the RRC sublayer of the protocol communication stack.

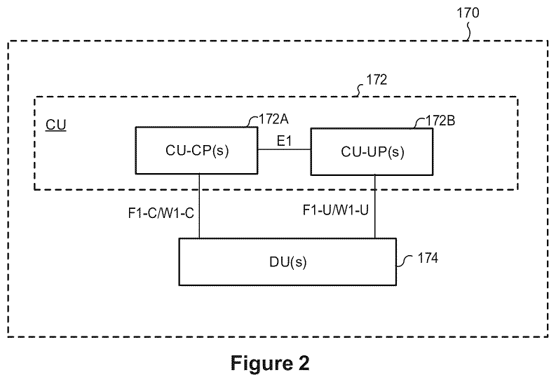

FIG. 2 depicts an example distributed or disaggregated implementation of any one or more of the BSs 104, 106. In this embodiment, the BS 170 (i.e., any one of BSs 104, 106) includes a central unit (CU) 172 having one or more CU control planes (CU-CPs) 172A and one or more CU user planes (CU-UPs) 172B, and one or more distributed units (DUs) 174. The CU 172 includes processing hardware, such as one or more general-purpose processors (e.g., CPUs) and a computer-readable memory storing machine-readable instructions executable on the general-purpose processor(s), and/or special-purpose processing units. For example, the CU 172 can include a PDCP controller, an RRC controller and/or an RRC inactive controller. In some embodiments, the CU 172 can include a radio link control (RLC) controller configured to manage or control one or more RLC operations or procedures. In further embodiments, the CU 172 does not include an RLC controller.

Each of the DUs 174 also includes processing hardware that can include one or more general-purpose processors (e.g., CPUs) and computer-readable memory storing machine-readable instructions executable on the one or more general-purpose processors, and/or special-purpose processing units. For example, the processing hardware can include a MAC controller configured to manage or control one or more MAC operations or procedures (e.g., a random access procedure), and/or an RLC controller configured to manage or control one or more RLC operations or procedures. The process hardware can also include a physical layer controller configured to manage or control one or more physical layer operations or procedures.

In some embodiments, the RAN 105 supports Integrated Access and Backhaul (IAB) functionality. In some embodiments, the DU 174 operates as an IAB-node, and the CU 172 operates as an IAB-donor. In some embodiments, the RAN 105 supports NTN functionality. In some embodiments, the CU 172 can include the logical node(s) CU-CP 172A that hosts the control plane part of the PDCP protocol of the CU 172. The CU 172 can also include the logical node(s) CU-UP 172B that hosts the user plane part of the PDCP protocol and/or Service Data Adaptation Protocol (SDAP) protocol of the CU 172. The CU-CP 172A can transmit control information (e.g., RRC messages, F1 application protocol messages), and the CU-UP 172B can transmit data packets (e.g., SDAP PDUs or Internet Protocol packets). The CU-CP 172A can be connected to multiple CU-UP 172B through the E1 interface. The CU-CP 172A can connect to one or more DU 174s through an F1-C interface. The CU-UP 172B can connect to one or more DU 174 through the F1-U interface under the control of the same CU-CP 172A.

FIG. 3A illustrates a certain type of NTN deployment 300A referred to as transparent payload architecture, which involves a satellite gateway 302 and a “transparent” satellite 304 for extending the range of the Uu interface. The satellite 304 implements a frequency conversion and a RF amplifier in both the uplink and downlink directions. The satellite function is similar to that of an analogue RF repeater. As a result, satellite 304 repeats the Uu radio interface from the feeder link (between the NTN gateway and the satellite) to the service link (between the satellite and the UE) in the downlink direction and vice versa in the uplink direction. The satellite radio interface (SRI) on the feeder link is the Uu, and the NTN gateway 302 supports all necessary functions to forward the signal of the Uu interface. The NTN gateway 302 can be placed at the same site as the BS (e.g., eNB, gNB) 104 location, or be connected to the BS 104 at a distance via a wired link. It is also possible to connect more than one NTN gateway to a BS. Different transparent satellites may be connected to the same BS on the ground, via the same NTN gateway, or via different NTN gateways. FIG. 3B illustrates the NTN deployment 300B where two different satellites (304 and 306) are connected to the same BS 104 via the same NTN gateway 302, and these two satellites (304 and 306) are covering the Earth surface using two different physical cell IDs (PCIs).

Although the transparent payload architecture illustrated in FIGS. 3A and 3B is the current focus of the 3GPP development, the regenerative payload architecture that installs the eNB or gNB functions on the satellite is also a possible NTN deployment in the future. In such an architecture, the Uu only exists between the satellite and the UE. In general, the techniques of this document can apply to the transparent payload architecture as well as the regenerative payload architecture.

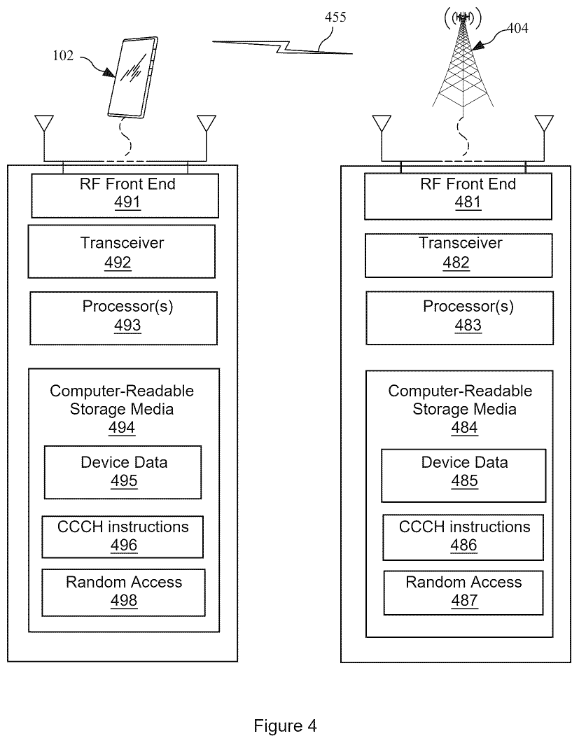

FIG. 4 is a block diagram illustrating structural elements of a UE 102 and a network entity, NE, 404 (e.g., BS) configured to perform methods for random access according to various embodiments discussed herein. NE 404 (which may be operated as BSs 104, 106 or RAN 105 in FIG. 1, or BS 170, CU 172, or DU 174 in FIG. 2) and UE 102 communicate wirelessly 455. NE 404 may be a BS operating in TN or NTN, but more generally, the term “network entity” stands in this document for a wired or wireless device with a well-defined network functionality in the TN or NTN (e.g., BS's functionality is connecting UEs to the core network including managing communications to and from the UEs). NE 404 may provide the functionality of an eNB (i.e., 4G base station) or a gNB (i.e., a 5G or 6G base station). NE 404's functionality may be distributed across multiple entities (e.g., a CU, a DU, and a radio unit, RU).

NE 404 includes antennas, an RF front end 481 and a transceiver 482 for communicating with UE 102 and other UEs and NEs. NE's antennas and RF front end 481 can be tuned to one or more frequency bands (e.g., subcarriers), for example as defined by 3GPP LTE, 5G NR, and 6G communication standards and implemented by transceiver 482. NE 404 further includes processor(s) 483 and computer-readable storage media (CRM) 484. Processor(s) 483 can include single or multiple-core processors, and CRM 484 includes any suitable memory/storage except propagating signals. For example, memory/storage can include random-access memory (RAM), static RAM (SRAM), dynamic RAM (DRAM), non-volatile RAM (NVRAM), read-only memory (ROM), and/or flash memory. CRM 484 stores device data 485, which includes network scheduling data, radio resource management data, applications, and/or an operating system, which are executable by processor(s) 483 to enable wireless communication with UE 102 as well as with other NEs and UEs. CRM 484 also stores CCCH related instructions 486 and random access procedure related executable instructions 487.

UE 102 includes antennas connected to an RF front end 491, and a transceiver 492. UE 102 may include multiple transceivers for supporting various technologies. The antennas and RF front end 491 can be tuned to one or more frequency bands (e.g., subcarriers), for example, as defined by 3GPP LTE, 5G NR, and 6G communication standards and implemented by respective transceivers. UE 102 also includes one or more processor(s) 493, and CRM 494. Processor(s) 493 may be single or multiple-core processors, and CRM 494 includes any suitable memory/storage (similar to CRM 484) other than propagating signals. CRM 494 stores device data 495 necessary for UE's communications, CCCH related instructions 496, and random access procedure related executable instructions 498. In some embodiments, the NE's and the UE's elements 486, 488, 496, and 498 may be implemented not only as software but also as hardware logic and/or circuitry.

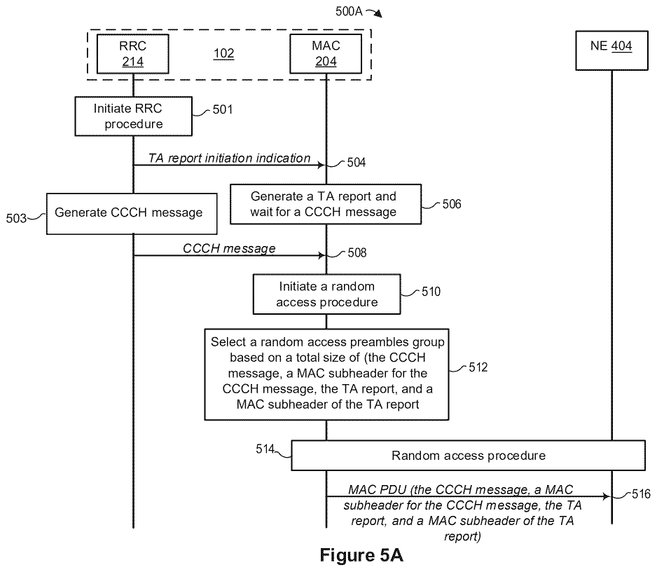

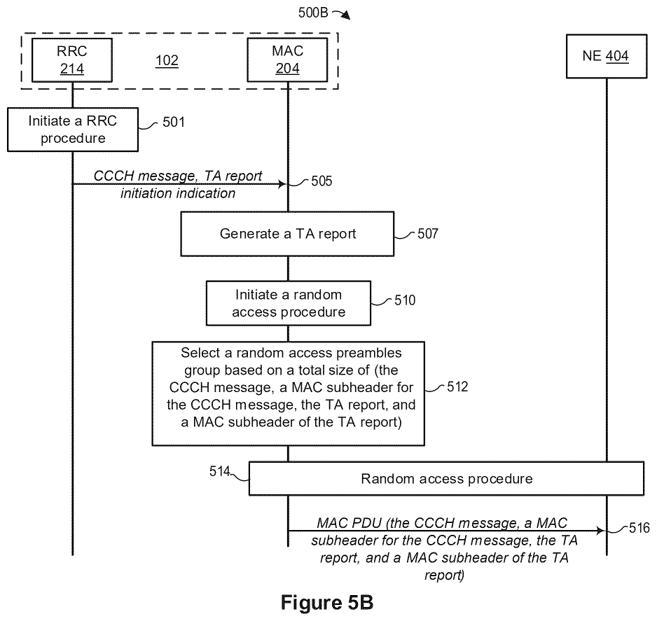

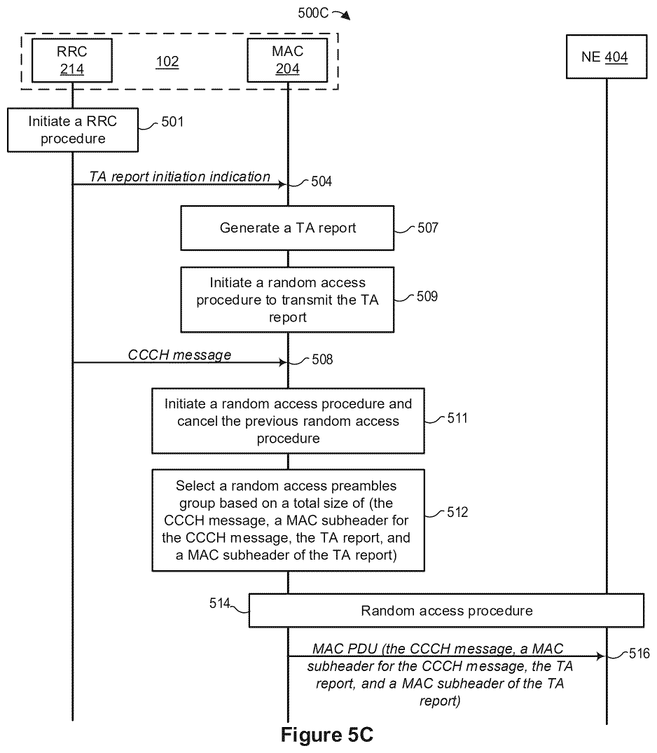

Next, several scenarios that involve several components of FIG. 1 and relate to communication of a CCCH message (i.e., a CCCH SDU) or the CCCH message and additional information, in a random access procedure, are discussed with reference to FIGS. 5A-5C. Generally, the same events in FIGS. 5A-5C are labeled with the same reference numbers. With the exception of the differences shown in the figures and discussed below, any of the alternative embodiments discussed with respect to a particular event (e.g., for messaging and processing) may apply to events in other figures.

Referring to FIG. 5A, which is a signal diagram schematically illustrating signals or commands exchanged between the UE 102 and NE 404 (which may be one of the BS or RAN in FIG. 1 or CU or DU in FIG. 2), in a scenario 500A, the UE 102 initiates 501 an RRC procedure (with the goal of establishing, resuming, or reestablishing connection with the NE) at an RRC sublayer 214. In response to the initiation 501, the RRC sublayer 214 sends 504 a TA report initiation indication to a MAC sublayer 204 of the UE 102, to request the MAC sublayer 204 to transmit a TA report. While this and other embodiments are discussed, for simplicity, with regard to a TA report initiation, one skilled in the art would understand that other information, instead of the TA report, may be generated and transmitted to the NE. For example, this other information is called herein “additional information,” and it may include one or more of MAC CE, control-plane data, and/or user-plane data. In some embodiments, the additional information also includes a MAC subheader of each MAC CE included in the additional information. Thus, the term “additional information” also includes the TA report, which is one type of a MAC CE, and a MAC subheader of the TA report. In some embodiments, the additional information includes a buffer status report and a MAC subheader of the buffer status report.

Upon receiving the TA report initiation indication 504, the MAC sublayer 204 generates 506 a TA report and waits for receiving a CCCH message from the RRC sublayer 214. The MAC sublayer 204 is configured to refrain 506 from triggering a scheduling request to transmit the TA report until receiving the CCCH message from the RRC sublayer 214. In some embodiments, because the TA report is a MAC CE, the MAC sublayer 204 also generates a MAC subheader for the TA report. After (e.g., in response to) the initiation 501, the RRC sublayer generates 503 a CCCH message of the RRC procedure. After transmitting 504 the TA report initiation indication, the RRC sublayer 214 transmits 508 the CCCH message to the MAC sublayer 214. In some embodiments, the MAC sublayer 204 generates the TA report after receiving the CCCH message. Note that the timing of steps 503 and 506 may be reversed or the same.

After receiving the CCCH message, the MAC sublayer 204 initiates 510 a random access procedure to simultaneously transmit the CCCH message and TA report. In response to the initiation 510, the MAC sublayer 204 selects 512 a first random access preambles group from a plurality of random access preambles groups, based not only on a size of the CCCH message, but also based on a size of the additional information (e.g., TA report). For example, in this embodiment, the MAC sublayer 204 selects 512 the first random access preambles group (i.e., group A or group B if only two groups are configured) based on a compounded size (e.g., a total size) of the CCCH message, a MAC subheader for the CCCH message, the TA report, and a MAC subheader of the TA report. Note that groups A and B were discussed in the Background section with respect to the random access procedure. One skilled in the art would understand that a network, TN or NTN, may use more than two groups of random access preambles and the embodiments discussed here should not be limited only to groups A and B. Only these two groups are discussed herein for simplicity. The MAC sublayer 204 then randomly selects a first random access preamble from the first random access preambles group and performs 514 the random access procedure with the NE 404 (e.g., the BS 104 or a DU of the BS 104 via satellite 304, in NTN 300A or 300B, or RAN node 105). Before or after initiating the RRC procedure 501 or the random access procedure 510, the UE 102 receives system information block(s) (SIB(s)) including configuration(s) setting up the plurality of random access preambles groups, from the NE 404.

As discussed above, each of the plurality of random access preambles groups (groups A and B) includes one or more different random access preambles, and each group is associated with a different message size range, which the UE 102 can transmit to the NE 404 during the random access procedure. The UE 102 determines the size range based on a preset size in the SIB(s) as described below. The random access procedure 514 can be a four-step (discussed above in the Background section with regard to messages 1 to 4) or a two-step random access procedure. Each scenario is discussed below in more detail. For example, the UL transmission may be a Msg3 (e.g., a MAC PDU) in the case of the four-step random access procedure. In another example, the UL transmission may be a MAC PDU of a message A (MsgA) in the case of the two-step random access procedure. The NE 404 can configure the plurality of random access preambles groups that are specific for a four-step random access procedure or for a two-step random access procedure. In some embodiments, the plurality of random access preambles groups include groups A and B discussed above. The random access preambles group A includes at least one random access preamble indicating a preset size (e.g., 56, 72, 144, 208, 256, 282, 480, 640, 800, 1000, 1280 or 1600 bits), and the random access preambles group B includes at least one random access preamble indicating a size larger than the preset size. These sizes define how much data the UE 102 can send to the NE 404 during a transmission. In this embodiment, the at least one random access preamble in the random access preambles group B includes the first random access preamble selected in step 512. The configuration(s) received by the UE from the RAN, prior to executing step 512, can include a configuration (e.g., ra-SizeGroupA, ra-Msg3SizeGroupA or ra-MsgA-SizeGroupA) indicating the preset size and include a configuration parameter indicating that the random access preambles group B is configured. The UE 102 (e.g., MAC sublayer 204) determines to use the first random access preamble because the compounded size considered/determined/calculated in step 512 is larger than the preset size. In this embodiment, the UE effectively calculates or estimates the compounded size of the CCCH message, the MAC subheader for the CCCH message, the TA report, and the MAC subheader of the TA report before selecting the first random access preamble. In another embodiment, the NE 404 may configure the UE 102 to perform this calculation or estimation.

When the NE 404 receives 514 the first random access preamble from the UE 102, during the four-step random access procedure, the NE 404 identifies or determines the first random access preambles group (e.g., the random access preambles group B in this scenario) as the first random access preamble belongs to this group. Based on the identified first random access preambles group, the NE 404 determines that the UE 102 desires to transmit a MAC PDU larger than the preset size, during the four-step random access procedure 514. Thus, NE 404 generates a first UL grant for the UE 102 and configures a transport block size (e.g., MAC PDU size) for the UE, larger than the preset size. The NE 404 then transmits a first random access response (RAR) including the first UL grant (i.e., RAR grant) to the UE 102 in response to the first random access preamble. The first UL grant indicates the size of a transport block (e.g., MAC PDU) that the UE 102 can transmit to the NE 404. In some embodiments, based on the first UL grant, the UE 102 generates a MAC PDU (i.e., Msg3), which includes the MAC subheader for the CCCH message, the CCCH message, the MAC subheader of the TA report, and the TA report, and transmits 516 the MAC PDU (e.g., Msg3) to the NE 404. A size of the MAC PDU 516 is equal to or smaller than the size provided in the first UL grant and thus, the UE 102 may or may not include padding in the MAC PDU 516. In response to receiving the MAC PDU 516, the NE 404 transmits a contention resolution identity to the UE 102 to indicate that the four-step random access procedure is successful. For example, the NE 404 can transmit a DL MAC PDU (e.g., Msg4) including the contention resolution identity (e.g., a MAC CE) to the UE 102 in a later step, not shown in FIG. 5A.

In some scenarios or embodiments, a UE (e.g., the UE 102 or another UE not shown in FIG. 5A) initiates the four-step random access procedure to transmit other data (not the TA report). The UE (e.g., a MAC sublayer 204 of the UE) determines or selects a second random access preambles group (e.g., the random access preambles group A in this scenario, but is possible to select any available group) of the plurality of random access preambles groups, because a size of the other data to be transmitted is smaller than or equal to the preset size. The UE selects a second random access preamble from the second random access preambles group, and transmits the second random access preamble to the NE 404, in response to initiating the four-step random access procedure. When the NE 404 receives the second random access preamble from the MAC 204, the NE 404 determines or identifies that the second random access preamble belongs to the second random access preambles group (i.e., group A in this specific scenario).

Based on the detected second random access preambles group, the NE 404 determines that the other data the UE desires to transmit is smaller than or equal to the preset size. The NE 404 then generates a second UL grant for the UE to transmit a MAC PDU with a second size, smaller than or equal to the preset size. In this embodiment, the second size is smaller than the first size because the second size is associated with group A and the first size is associated with group B and by their configurations, group B affords a larger size than group A. The NE 404 then transmits a second RAR (not shown in the figures) including the second UL grant to the UE in response to the second random access preamble. The UE generates a MAC PDU including the other data desired to be transmitted, using the second UL grant, and transmits the MAC PDU (i.e., Msg3) to the NE 404 using the second UL grant. In response to receiving the MAC PDU, the NE 404 transmits a contention resolution identity to the UE to indicate the four-step random access is successful. For example, the NE 404 can transmit a DL MAC PDU including the contention resolution identity (e.g., a MAC CE) to the UE.

In cases where the random access procedure 514 is a two-step random access procedure, the UE 102 determines or selects a first physical uplink share channel (PUSCH) resource configuration (e.g., msgA-PUSCH-ResourceGroupB-r16) associated with the first random access preambles group, and the first PUSCH resource configuration can accommodate a compounded size of the CCCH message, the MAC subheader for the CCCH message, the TA report, and the MAC subheader of the TA report. The UE 102 receives the first PUSCH resource configuration in a SIB broadcast by the NE 404. The UE 102 can receive a SIB including the first PUSCH resource configuration from the NE 404 via broadcast. The UE 102 then generates a MAC PDU including the CCCH message, the MAC subheader for the CCCH message, the TA report, and the MAC subheader of the TA report, based on the first PUSCH resource configuration. Afterwards, the UE 102 transmits 514 the first random access preamble, and transmits 516 the first PUSCH transmission including the MAC PDU to the NE 404. Depending on a MAC PDU size configured by the first PUSCH resource configuration, the UE 102 may or may not include padding bits in the MAC PDU 516.

Specifically, the UE 102 transmits 516 the first PUSCH transmission to the NE 404 in accordance with the first PUSCH resource configuration. In such cases, the first PUSCH transmission is part of the two-step random access procedure 514. When the NE 404 receives the first random access preamble and the first PUSCH transmission from the UE 102, the NE 404 identifies or determines a random access preambles group (i.e., the first random access preambles group) associated with the first random access preamble. Based on the identified first random access preambles group, the NE 404 determines that the first PUSCH resource configuration is used by the UE 102 to transmit the first PUSCH transmission. Based on the first random access preambles group and/or the determined PUSCH resource configuration (i.e., the first PUSCH resource configuration), the NE 404 receives and/or decodes the PUSCH transmission to obtain the MAC PDU 516. After (e.g., in response to) receiving the MAC PDU 516, the NE 404 transmits a contention resolution identity to the UE 102. For example, the NE 404 can transmit a DL MAC PDU including the contention resolution identity (e.g., a MAC CE) to the UE 102. The NE 404 can generate a RAR (e.g., success RAR) including the contention resolution identity and transmit a DL MAC PDU including the RAR to the UE 102. In some embodiments, the UE 102 determines or selects the first random access preambles group because the compounded size of the CCC message and the additional information is larger than the preset size. The first PUSCH resource configuration may configure a size of MAC PDU (e.g., a first size) to be larger than the preset size.

In some scenarios or embodiments, a UE (e.g., the UE 102 or another UE not shown in FIG. 5A) initiates a two-step random access procedure to transmit data (different from the CCC message and TA report or additional data discussed above). In response to the initiation, the UE selects or determines a second random access preambles group (e.g., the random access preambles group A) of the plurality of random access preambles groups. The UE 102 selects a second random access preamble and a second PUSCH resource configuration associated with the second random access preambles group, because a size of the data is smaller than or equal to the preset size. The second PUSCH resource configuration configures a MAC PDU size (e.g., a second size) smaller than or equal to the preset size. Typically, the second size is smaller than the first size because of the specific implementations of groups A and B discussed in this embodiment. The UE generates a MAC PDU including the data and generates a second PUSCH transmission of the MAC PDU, using the second PUSCH resource configuration. The UE transmits to the NE 404 a MsgA including the second random access preamble and the second PUSCH transmission. The SIB configures or includes the second PUSCH resource configuration (e.g., msgA-PUSCH-Resource GroupA-r16) and the UE receives the SIB from the NE 404 before transmitting the second PUSCH transmission. The UE generates the second PUSCH transmission of a MAC PDU using the second PUSCH resource configuration. In such cases, the NE 404 determines or identifies that the second random access preamble belongs to the second random access preambles group (i.e., group A in this case). Based on the second random access preambles group, the NE 404 determines that the UE uses the second PUSCH resource configuration to transmit the second PUSCH transmission. Based on the second random access preambles group and/or the determined PUSCH resource configuration (i.e., the second PUSCH resource configuration), the NE 404 receives and/or decodes the second PUSCH transmission. After (e.g., in response to) receiving the MAC PDU, the NE 404 transmits a contention resolution identity to the UE. For example, the NE 404 can transmit a DL MAC PDU including the contention resolution identity (e.g., a MAC CE) to the UE. The NE 404 can generate a RAR (e.g., success RAR) including the contention resolution identity and transmits a DL MAC PDU, including the RAR, to the UE.

In some embodiments, the UE 102 receives, from the NE 404, a TA report enabled flag (e.g., ta-Report field/IE) instructing the UE 102 to transmit a TA report via a broadcast signaling or a dedicated signaling. For example, the UE 102 receives a SIB including the TA report enabled flag from the NE 404. In another embodiment, the UE 102 receives a dedicated RRC message including the TA report enabled flag from the NE 404, before the UE 102 initiates the RRC procedure and while the UE 102 operates in a connected state (e.g., RRC_CONNECTED). The dedicated RRC message can be an RRC reconfiguration message (e.g., RRCReconfiguration message) or an RRC release message (e.g., RRCRelease message). The RRC reconfiguration message may include a reconfigurationWith Sync IE.

In some other embodiments, the RRC procedure 501 is an RRC connection establishment procedure and the UE 102 (e.g., the RRC sublayer 214) operates in an idle state (e.g., RRC_IDLE) to initiate the RRC connection establishment procedure 501. In such cases, the CCCH message 508 includes an RRC setup request (e.g., RRCSetupRequest message). The NE 404 transmits a CCCH message (not to be confused with the CCCH message 508) including an RRC setup message (e.g., RRCSetup message) to the UE 102 (e.g., the RRC sublayer 214) in response to the RRC setup request message. In response, the UE 102 (e.g., the RRC sublayer 214) transmits a dedicated control channel (DCCH) message including an RRC setup complete message (e.g., RRCSetupComplete message) to the NE 404.

In other embodiments, the RRC procedure 501 is an RRC connection resume procedure and the UE 102 (e.g., RRC sublayer 214) operates in an inactive state (e.g., RRC_INACTIVE) to initiate the RRC connection resume procedure. In such cases, the CCCH message 508 includes an RRC resume request (e.g., RRCResumeRequest or RRCResumeRequest1 message). The NE 404 transmits a CCCH message including an RRC resume message (e.g., RRCResume message) to the UE 102 (e.g., the RRC sublayer 214) in response to the RRC resume request message. In response, the UE 102 (e.g., the RRC sublayer 214) transmits a DCCH message including an RRC resume complete message (e.g., RRCResumeComplete message) to the NE 404.

In yet other embodiments, the RRC procedure 501 is an RRC connection reestablishment procedure and the UE 102 (e.g., the RRC sublayer 214) operates in a connected state (e.g., RRC_CONNECTED) to initiate the RRC connection reestablishment procedure 501. In such cases, the CCCH message 508 includes an RRC reestablishment request (e.g., RRCReestablishmentRequest message). The NE 404 transmits a CCCH message including an RRC reestablishment message (e.g., RRCReestablishment message) to the UE 102 (e.g., the RRC sublayer 214) in response to the RRC reestablishment request message. In response, the UE 102 (e.g., the RRC sublayer 214) transmits a DCCH message including an RRC reestablishment complete message (e.g., RRCReestablishmentComplete message) to the NE 404.

Turning to FIG. 5B, a scenario 500B is similar to scenario 500A. While the RRC sublayer 214 in scenario 500A separately transmits 504 and 508 the TA report initiation indication and the CCCH message to the MAC sublayer 204, the RRC sublayer 214 in scenario 500B simultaneously transmits 505 the CCCH message and TA report initiation indication to the MAC sublayer 204, e.g., in the same inter-process communication (IPC) message or as two different messages. Thus, the MAC sublayer 204 generates 507 the TA report in response to the TA report initiation indication. Because the MAC sublayer 204 receives at the same time the CCCH message and TA report indication from the RRC sublayer 214, the MAC sublayer 204 does not wait for receiving the CCCH message from the RRC sublayer 214, as in scenario 500A.

Turning to FIG. 5C, a scenario 500C is similar to scenarios 500A and 500B. While the UE 102 in scenario 500A generates 506 the TA report and waits 506 for the CCCH message to be received from the RRC sublayer 214, according to the scenario 500C, the UE 102 generates 507 the TA report and then initiates 509 a random access procedure for sending the TA report without waiting for the CCCH message. Thus, the MAC sublayer 204 generates 507 the TA report in response to the TA report initiation indication 504 and initiates 509 the random access procedure to transmit the TA report, before receiving the CCCH message 508, assuming that the UE 102 is configured with timingadvanceSR equal to “enabled.” After receiving the CCCH message 508, the MAC sublayer 204 initiates 511 another random access procedure and let the initial random access procedure 509 fail, for example, by not responding to a message received from the NE 404. The random access procedure 511 is similar to the procedure 510. In another embodiment, after receiving the CCCH message 508, the MAC sublayer 204 may not yet have transmitted the random access preamble for the random access procedure initiated in step 509. In this case, the MAC sublayer 204 may cancel the transmission of the random access preamble for the random access procedure 509, and then initiates 511 another random access procedure triggered by the reception of the CCCH message 508.

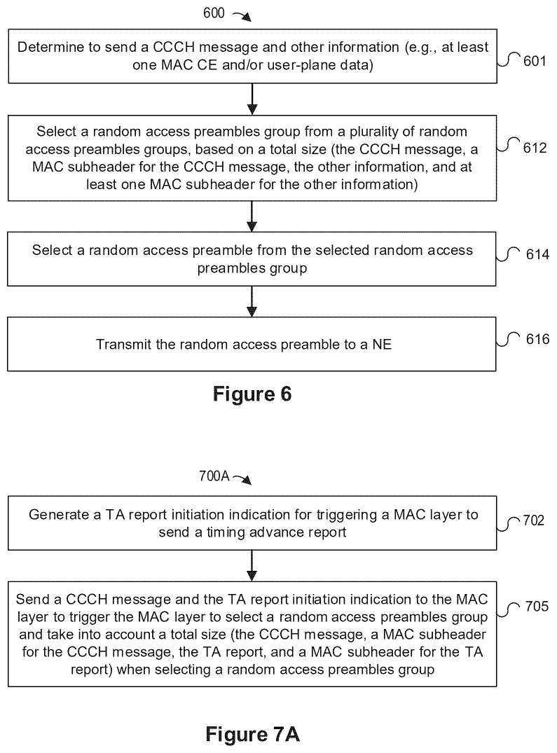

Next, several example methods that can be implemented in a UE (e.g., the UE 102) or a NE (such as a RAN node 105, a BS 104 or 106 or a DU or CU of a BS) are discussed with reference to FIGS. 6-16. Each of these methods can be implemented using processing hardware as illustrated in FIG. 4. The identical steps in FIGS. 6-16 are labeled with the same reference numbers, i.e., a step x02 is essentially the same no matter the value of x. With the exception of the differences shown in the figures and discussed below, any of the alternative implementations discussed with respect to a particular event (e.g., for messaging and processing) may apply to events labeled with the same reference numbers in other figures.

FIG. 6 illustrates a method 600, which can be implemented by a UE (e.g., the UE 102), for managing random access with a NE (e.g., the DU 174, BS 104 or 106, or RAN 105). The method 600 begins at step 601, where the UE determines to send a CCCH message and additional information (e.g., event 501 in FIG. 5A). At step 612, the UE selects a random access preambles group from a plurality of random access preambles groups, based on a compounded size of the CCCH message, the MAC subheader for the CCCH message, the additional information desired to be sent, e.g., TA report, and at least one MAC subheader for the additional information (e.g., event 512 in FIG. 5A). At step 614, the UE (randomly) selects a random access preamble from the selected random access preambles group. At step 616, the UE transmits the selected random access preamble to the RAN (e.g., event 514 in FIG. 5B).

In some embodiments, the additional information includes at least one of MAC CE, control-plane data, and/or user-plane data. Each of the at least one MAC subheader for the additional information corresponds to a particular MAC CE in the at least one MAC CE and/or data associated with a particular logical channel. For example, the at least one MAC CE includes a first MAC CE for the TA report, a second MAC CE for a Positioning Measurement Gap Activation/Deactivation Request, and/or a third MAC CE for a buffer status report. In such cases, the at least one MAC subheader includes a first MAC subheader, a second MAC subheader and/or a third MAC subheader for the first MAC CE, second MAC CE and/or third MAC CE, respectively. The control-plane data includes data associated with DCCH(s). The at least one MAC CE may include a fourth MAC CE for control-plane data associated with a DCCH. The user-plane data includes data associated with DTCH(s). The at least one MAC CE may include a fifth MAC CE for user-plane data associated with a DTCH.

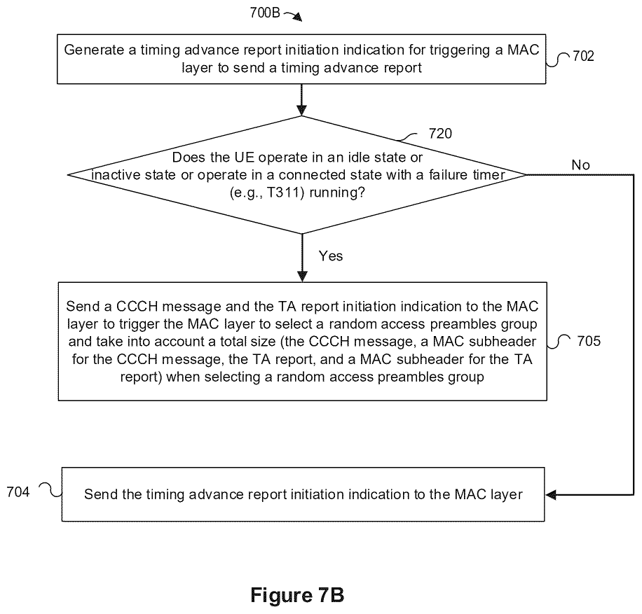

FIG. 7A illustrates a method 700A, which can be implemented by a UE (e.g., the RRC sublayer 214 of the UE 102), for managing random access with a NE (e.g., the CU 172, DU 174, BS 104 or 106, or RAN 105). The method 700A begins at step 702, where the UE generates a TA report initiation indication for triggering a MAC layer to send a TA report. For example, the MAC layer is the MAC sublayer 204. At step 705, the UE sends a CCCH message and the TA report initiation indication to the MAC layer to trigger the MAC layer to select a random access preambles group and account for a compounded size of the CCCH message, a MAC subheader for the CCCH message, the TA report, and a MAC subheader for the TA report, when selecting the random access preambles group (e.g., event 505 in FIG. 5A).

FIG. 7B illustrates a method 700B similar to the method 700A, except for a determination step 720 in which the UE distinguishes whether it operates in (1) an idle or inactive state or a connected state with a failed timer, or (2) none of the states in (1). The method 700B begins at step 702, where the UE generates a TA report initiation indication for triggering the MAC layer to send the TA report. At step 720, the UE determines whether the UE operates in an idle state or inactive state or operates in a connected state with a failure timer (e.g., timer T311) running. If the UE determines 720 that the UE operates in the idle state or inactive state or operates in the connected state with the failure timer (e.g., T311) running, the flow proceeds to step 705, which was discussed above and thus, it is not repeated here. Otherwise (e.g., the UE determines 720 that the UE operates in a connected state without a failure timer (e.g., T311) running), the UE sends 704 the TA report initiation indication to the MAC layer. In some embodiments, the UE sends 704 a DCCH message (e.g., RRCReconfigurationComplete message) to the MAC layer. In other embodiments, the UE sends 704 the DCCH message to the MAC layer after sending the TA report initiation indication to the MAC layer. In some embodiments, the idle state, inactive state, and/or connected state are RRC_IDLE state, RRC_INACTIVE state, and/or RRC_CONNCTED state, respectively.

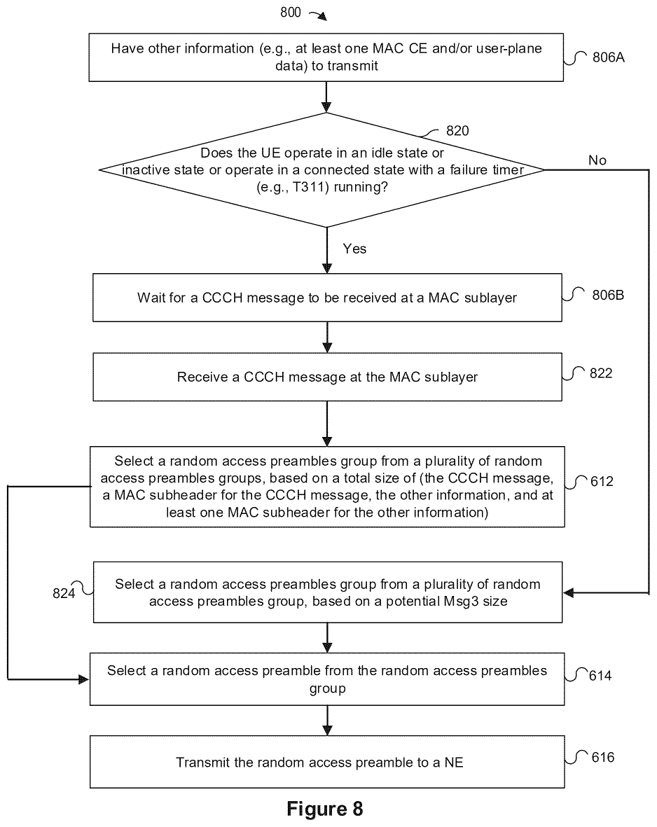

FIG. 8 illustrates a method 800, which can be implemented by a UE (e.g., the UE 102), for managing random access with a NE (e.g., the CU 172, DU 174, BS 104 or 106, or RAN 105). The method 800 begins at step 806A, where the UE has additional information to transmit, e.g., at least one MAC CE and/or user-plane data (e.g., events 506, 507 in FIGS. 5A to 5C). At step 820, the UE determines whether the UE operates in an idle state or inactive state or has a running failure timer (e.g., T311). If the UE determines 820 that the UE operates in one of these conditions, the UE waits 806B for a CCCH message to be received at a MAC sublayer (e.g., event 506 in FIG. 5A). At step 822, the UE receives a CCCH message at the MAC sublayer (e.g., event 508). The flow then proceeds to steps 612, 614, and 616, which were discussed above. Otherwise (e.g., if the UE determines 820 that the UE operates in a connected state without a failure (e.g., T311) timer running), the UE selects 824 a random access preambles group from a plurality of random access preambles groups, based on a potential Msg3 size, e.g., given that no sufficient PUSCH resource is available for a new transmission. The flow proceeds to steps 614 and 616. Depending on implementations or the potential Msg3 size, the random access preambles group selected at step 824 can be the same as, or different from, the random access preambles group selected at step 612.

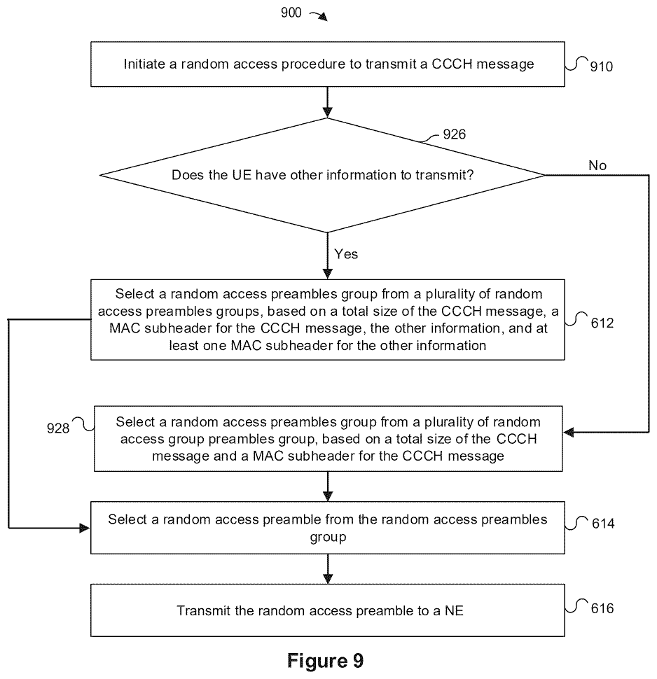

FIG. 9 illustrates a method 900, which can be implemented by a UE (e.g., the UE 102), for managing random access with a NE (e.g., the CU 172, DU 174, BS 104 or 106, or RAN 105). The method 900 begins at step 910, where the UE initiates a random access procedure to transmit a CCCH message (e.g., event 510 in FIG. 5A). At step 926, the UE determines/estimates whether the UE has additional information (i.e., information in addition to the CCCH message) to transmit. If the UE determines/estimates 926 that the UE has additional information to transmit, the flow proceeds to steps 612, 614, and 616. Otherwise, if the UE determines/estimates 926 that the UE does not have additional information to transmit, the flow proceeds to steps 928, 614, and 616. At step 928, the UE selects a random access preambles group from a plurality of random access preambles groups, based on a size of the CCCH message and a MAC subheader for the CCCH message, and not based on the compounded size. Examples and embodiments described for FIG. 6 can apply to FIG. 9.

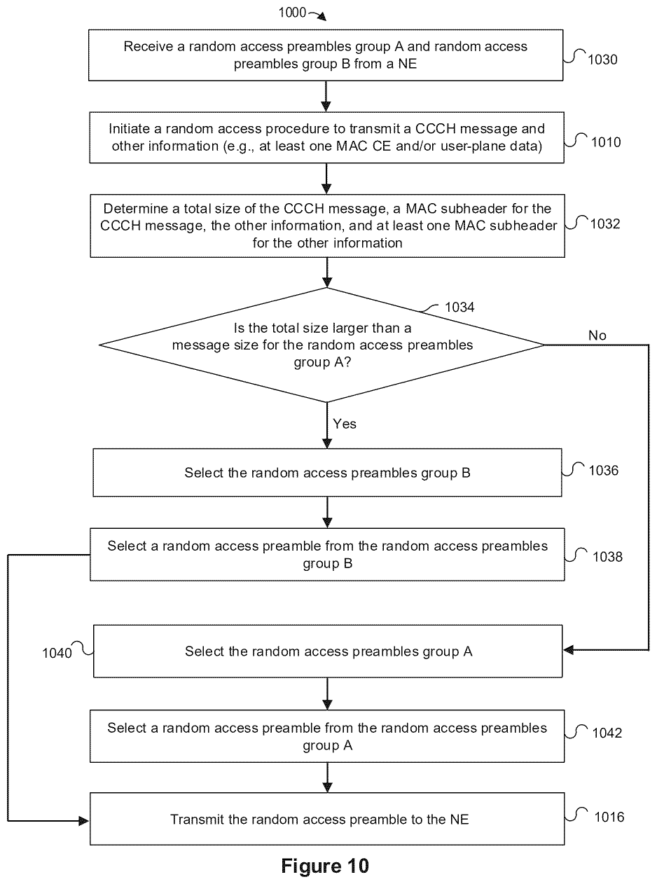

FIG. 10 illustrates a method 1000, which can be implemented by a UE (e.g., the UE 102), for managing random access with a NE (e.g., the CU 172, DU 174, BS 104 or 106, or RAN 105). The method 1000 begins at step 1030, where the UE receives a random access preambles group A and a random access preambles group B from the NE. As previously discussed, in one embodiment it is possible to receive more than two groups and this method is applicable to any number of groups. For example, the UE receives from the NE a SIB indicating the random access preambles group A and random access preambles group B. At step 1010, the UE initiates a random access procedure (e.g., event 510 in FIG. 5A) to transmit a CCCH message and additional information (e.g., at least one MAC CE and/or user-plane data). At step 1032, the UE determines a compounded size of (1) the CCCH message, (2) a MAC subheader for the CCCH message, (3) the additional information, and (4) at least one MAC subheader for the additional information (e.g., event 512). At step 1034, the UE determines whether the compounded size is larger than a message size (e.g., ra-SizeGroupA, ra-Msg3SizeGroupA or ra-MsgA-SizeGroupA) for the random access preambles group A. If the UE determines 1034 that the compounded size is larger than the message size for the random access preambles group A, the UE selects 1036 the random access preambles group B (e.g., event 512). At step 1038, the UE selects a random access preamble from the random access preambles group B selected in step 1036 and then transmits 1016 the selected random access preamble to the NE (e.g., event 514). Otherwise, if the UE determines 1034 that the compounded size is not larger than (e.g., equal to or smaller than) the message size for the random access preambles group A, the UE selects 1040 the random access preambles group A (e.g., event 512). At step 1042, the UE selects a random access preamble from the random access preambles group A and then the flow moves to step 1016. Examples and implementations described for FIG. 6 can apply to FIG. 10.

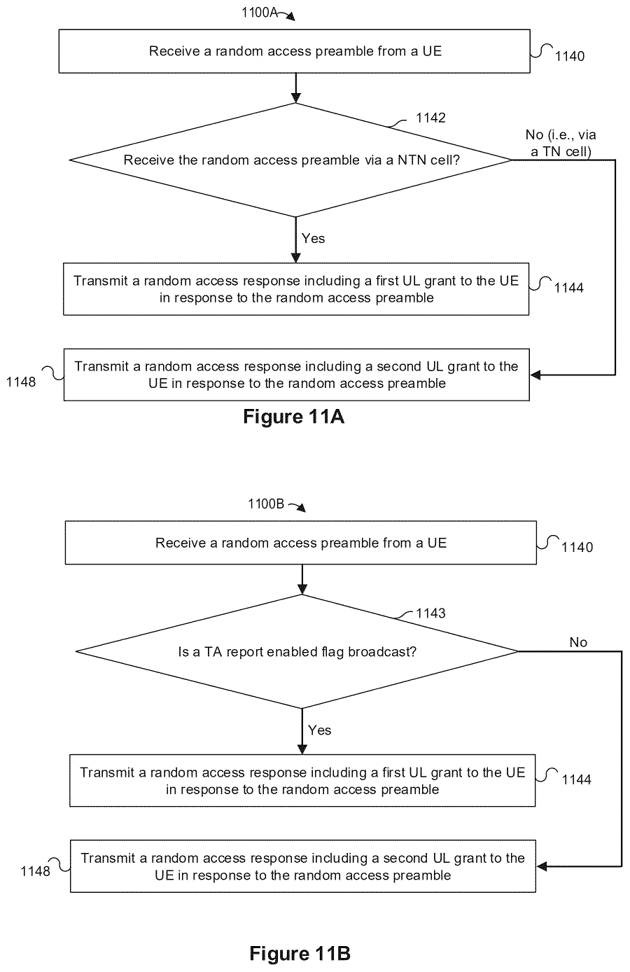

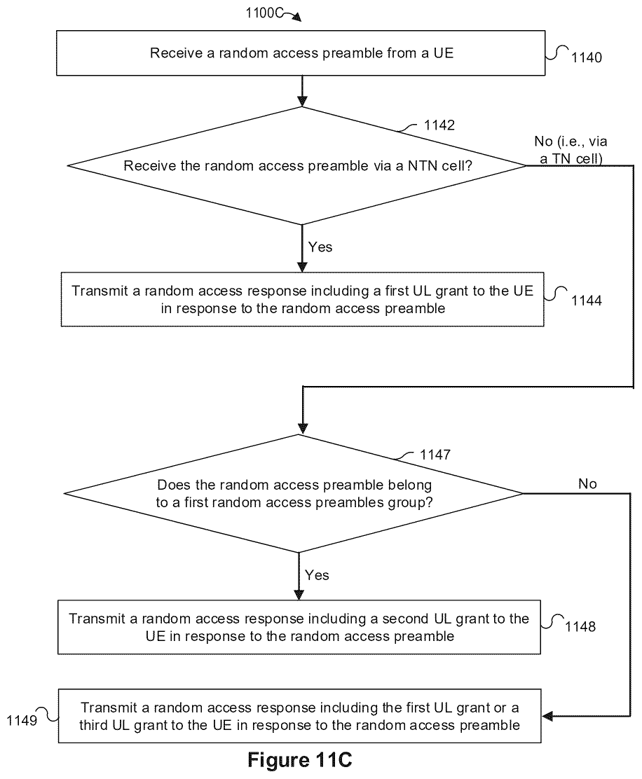

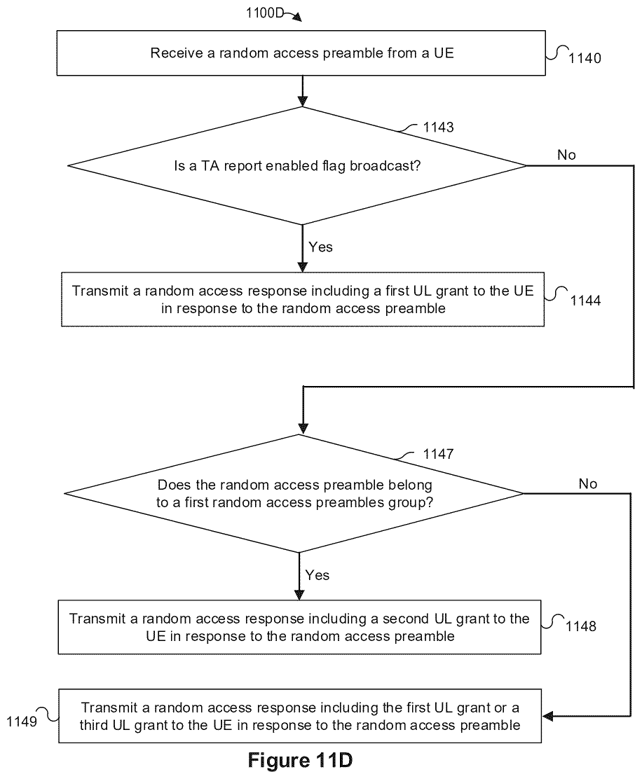

FIG. 11A illustrates a method 1100A, which can be implemented by a NE (e.g., the CU 172, DU 174, BS 104 or 106, or RAN node 105), for managing random access (e.g., four-step random access procedure) with a UE (e.g., the UE 102). The method 1100A begins at step 1140, where the NE receives a random access preamble from a UE (e.g., event 514). At step 1142, the NE determines whether the random access preamble is received via an NTN cell. If the NE determines 1142 that the random access preamble is/was received via the NTN cell, the NE transmits 1144 a random access response, including a first UL grant, to the UE in response to the random access preamble (e.g., event 514 in FIG. 5A). Still at step 1144, the NE may determine that the UE intends to send a TA report (or other additional information) together with a CCCH message. Note that for an NTN cell, a TA report is usually transmitted by the UE during the random access procedure. Thus, the NE generates the first UL grant for the UE to transmit a MAC PDU including the CCCH message, a MAC subheader for the CCCH message, the TA report, and a MAC subheader of the TA report, as described above. Thus, the UE can transmit the CCCH message, the MAC subheader for the CCCH message, the TA report, and the MAC subheader of the TA report in a single MAC PDU. Otherwise, if the NE determines 1142 that the random access preamble is/was received via a non-NTN cell (i.e., a TN cell), the NE transmits 1148 to the UE a random access response, including a second UL grant, in response to the random access preamble (e.g., event 514). In some embodiments, the second UL grant configures a MAC PDU size to be smaller than the MAC PDU size of the first UL grant.

FIG. 11B is a flow diagram of an example method 1100B similar to the method 1100A, except that method 1100B includes step 1143 instead of step 1142. At step 1143, the NE determines whether a TA report enabled flag is broadcast (e.g., in a SIB) to the EU. For example, the TA report enabled flag is a ta-Report field/IE. If the NE determines 1143 that a TA report enabled flag is broadcasted to the EU, the flow proceeds to step 1144. Otherwise, if the NE determines 1143 that a TA report enabled flag is not broadcasted, the flow proceeds to step 1148. In some embodiments, the TA report enabled flag is a ta-Report field.

FIG. 11C is a flow diagram of an example method 1100C similar to the method 1100A, except that method 1100C includes steps 1147 and 1149. If the NE determines 1142 that the random access preamble is/was received via the NTN cell, the flow proceeds to step 1144, discussed above, i.e., a first UL grant is generated and transmitted to the UE. If the NE determines 1142 that the random access preamble is/was received via a non-NTN cell (i.e., a TN cell), the NE determines 1147 whether the random access preamble belongs to a first random access preambles group (e.g., the random access preambles group A). If the NE determines 1147 that the random access preamble belongs to the first random access preambles group, the flow proceeds to step 1148, where a second UL grant is generated and transmitted to the UE. Otherwise, if the NE determines 1147 that the random access preamble belongs to a second random access preambles group (e.g., the random access preambles group B), the NE transmits 1149 a random access response including the first UL grant or a third UL grant to the UE, in response to the random access preamble. In some embodiments, the third UL grant configures a MAC PDU size larger than the one of the second UL grant.

FIG. 11D is a flow diagram of an example method 1100D that includes selected steps from the methods 1100B and 1100C, in a different order. If the NE determines 1143 that a TA report enabled flag is not broadcasted to the EU, the flow proceeds to step 1147 discussed above.

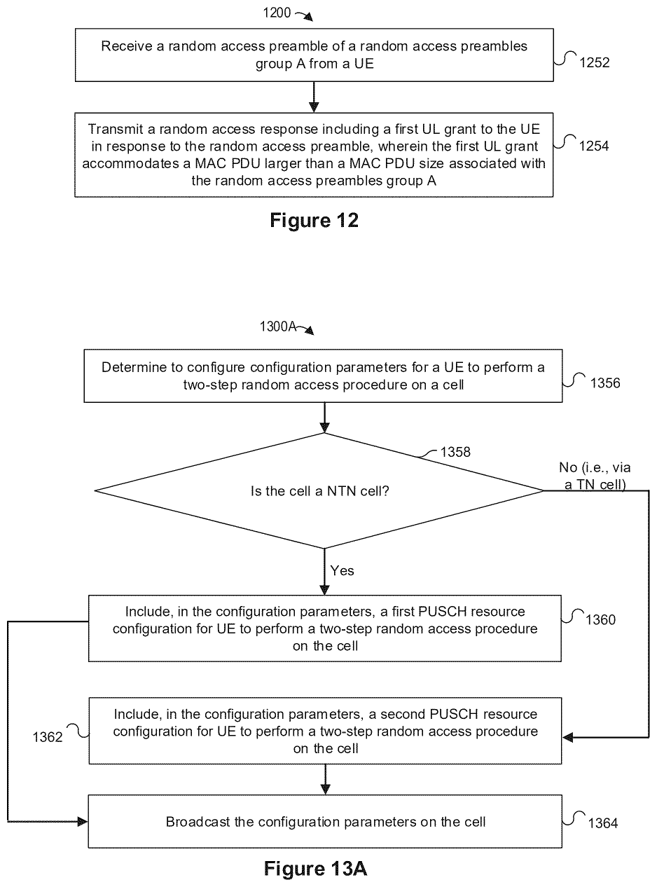

FIG. 12 illustrates a method 1200, which can be implemented by a NE (e.g., the CU 172, DU 174, BS 104 or 106, or RAN node 105), for managing random access with a UE (e.g., the UE 102). The method 1200 begins at step 1252, where the NE receives a random access preamble of a random access preambles group A from a UE (e.g., event 514 in FIG. 5A). At step 1254, the NE transmits, to the UE, a random access response, including a first UL grant, in response to the received random access preamble. The first UL grant can accommodate a MAC PDU larger than a MAC PDU size associated with the random access preambles group A (e.g., event 514).

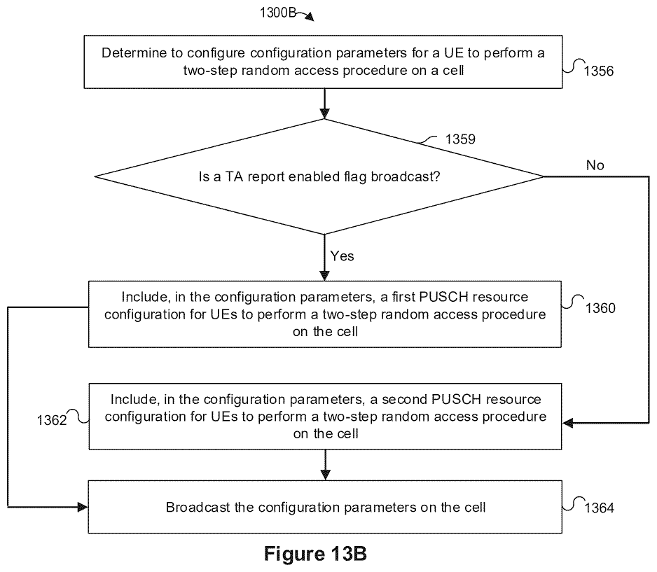

FIG. 13A illustrates a method 1300A, which can be implemented by a NE (e.g., the CU 172, DU 174, BS 104 or 106, or RAN node 105), for managing random access (e.g., two-step random access procedure) with a UE (e.g., the UE 102). The method 1300A begins at step 1356, where the NE determines to configure UE's configuration parameters to perform a two-step random access procedure on a given cell. At step 1358, the NE determines whether the given cell is an NTN cell. If the NE determines 1358 that the given cell is an NTN cell, the NE includes 1360 a first PUSCH resource configuration, in the UE's configuration parameters, so that the UE performs the two-step random access procedure via the given cell. Otherwise, if the given cell is a TN cell at step 1358, the NE configures 1362 a second PUSCH resource configuration, in the configuration parameters, for the UE to perform the two-step random access procedure via the given cell. The flow then proceeds to step 1364, from both step 1360 and step 1362. At step 1364, the NE broadcasts the configuration parameters to the UE, via the given cell.

FIG. 13B is a flow diagram of an example method 1300B similar to the method 1300A, except that method 1300B includes step 1359 instead of step 1358. At step 1359, the NE determines whether a TA report enabled flag is broadcasted (e.g., in a SIB). For example, the TA report enabled flag is a ta-Report field/IE. If the NE determines 1359 a TA report enabled flag is broadcasted to the UE, the flow proceeds to steps 1360. Otherwise, if the NE determines 1359 that a TA report enabled flag is not broadcasted, the flow proceeds to step 1362.

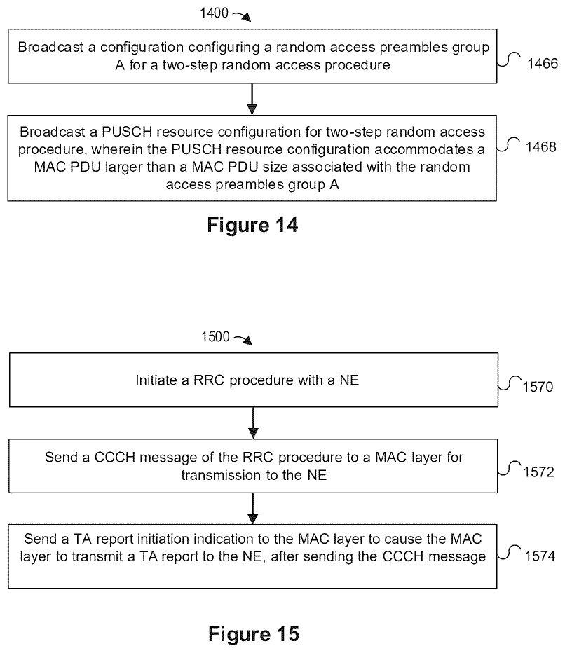

FIG. 14 illustrates a method 1400, which can be implemented by a NE (e.g., the CU 172, DU 174, BS 104 or 106, or RAN node 105), for managing random access with a UE (e.g., the UE 102). The method 1400 begins at step 1466, where the NE broadcasts to the UE a configuration structure configuring a random access preambles group A for a two-step random access procedure. At step 1468, the NE broadcasts a PUSCH resource configuration for the two-step random access procedure. The PUSCH resource configuration accommodates a MAC PDU larger than a MAC PDU size associated with the random access preambles group A. In some embodiments, the PUSCH resource configuration is an MsgA-PUSCH-Config IE.

In some embodiments, the NE receives a random access preamble of the random access preambles group A and receives and/or decodes a PUSCH transmission from a UE using the UL grant (e.g., event 514 in FIG. 5A). In some embodiments, the PUSCH transmission includes a MAC PDU and the MAC PDU includes a CCCH message, a MAC subheader for the CCCH message, a TA report, and a MAC subheader of the TA report, as described above.

FIG. 15 illustrates a method 1500, which can be implemented by an RRC layer of a UE (e.g., the RRC layer 214 of the UE 102), for managing TA reporting to a NE (e.g., the DU 174, BS 104 or 106, or RAN node 105). The method 1500 begins at step 1570, where the RRC layer initiates an RRC procedure (e.g., event 501 in FIG. 5A). At step 1572, the RRC layer sends a CCCH message of the RRC procedure to a MAC layer of the UE 102 for transmission to the NE (e.g., event 508 in FIG. 5A). At step 1574, the RRC layer sends a TA report initiation indication to the MAC layer 204 to cause the MAC layer to transmit a TA report to the NE, after sending the CCCH message (e.g., event 504). In such cases, the order of evets 504 and 508 in FIGS. 5A and 5C is reversed.

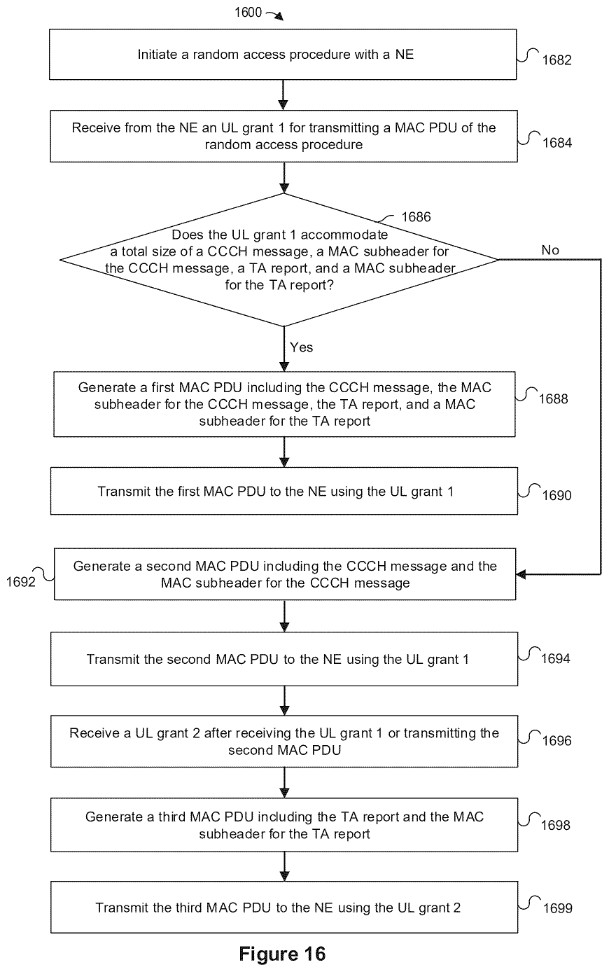

FIG. 16 illustrates a method 1600, which can be implemented by a UE (e.g., the UE 102), for managing random access with a NE (e.g., the CU 172, DU 174, BS 104 or 106, or RAN node 105). The UE is initially agnostic about which random access preambles group was sent by the NE. The method 1600 begins at step 1682, where the UE initiates a random access procedure with a NE (e.g., events 510, 511 in FIG. 5A). At step 1684, the UE receives from the NE an UL grant 1 for transmitting a MAC PDU of the random access procedure (e.g., event 514). In some embodiments, the UL grant 1 is the first UL grant described for FIG. 5A. In other embodiments, the UL grant 1 is the second UL grant described for FIG. 5A.

At step 1686, the UE determines whether the UL grant 1 accommodates a compounded size of a CCCH message, a MAC subheader for the CCCH message, a TA report, and a MAC subheader for the TA report. If the UE determines 1686 that the UL grant 1 accommodates the compounded size, the flow proceeds to step 1688 to generate a first MAC PDU including the CCCH message, the MAC subheader for the CCCH message, the TA report, and the MAC subheader for the TA report (e.g., event 516). At step 1690, the UE transmits the first MAC PDU to the NE using the UL grant 1 (e.g., event 516).

Otherwise, if the UE determines 1686 that the UL grant 1 does not accommodate the compounded size, the UE generates 1692 a second MAC PDU including the CCCH message and the MAC subheader for the CCCH message. At step 1694, the UE transmits the second MAC PDU to the RAN using the UL grant 1. At step 1696, the UE receives a UL grant 2, after receiving the UL grant 1 or transmitting the second MAC PDU. At step 1698, the UE generates a third MAC PDU including the TA report and the MAC subheader for the TA report. At step 1699, the UE transmits the third MAC PDU to the NE using the UL grant 2.

The following description may be applied to the description above. The description for one of the above figures can apply to another of the above figures. Examples, implementations and methods described above can be combined, if there is no conflict. An event or step described above can be optional or omitted. For example, an event or step with dashed lines in the figures can be optional. In some embodiments, the term “message” is used and can be replaced by “information element (IE)”, and vice versa. In some embodiments, the term “IE” is used and can be replaced by “field”, and vice versa. In some embodiments, the term “configuration” can be replaced by “configurations” or “configuration parameters”, and vice versa.

A user device in which the techniques of this document can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this document as including logic or a number of components or modules. Modules may be software modules (e.g., code, or machine-readable instructions stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC), a digital signal processor (DSP), etc., to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

1-17. (canceled)

18. A wireless communication method performed by a network entity, NE, the method comprising:
receiving a random access preamble from a user equipment, UE;
transmitting a first random access response, RAR, including a first uplink, UL, grant to the UE for a first condition; and
transmitting a second RAR, including a second UL grant to the UE for a second condition,
wherein the first UL grant is different from the second UL grant, and
wherein the first and second conditions being a terrestrial or non-terrestrial type of network cell on which the NE receives the random access preamble or whether a timing advance, TA, report flag is enabled.

19. The method of claim 18, wherein the first condition includes a random access preamble being received from the UE via a non-terrestrial network, NTN, cell, and the second condition includes the random access preamble being received from the UE via a terrestrial network, TN, cell.

20. The method of claim 18, wherein the first condition includes a TA report enable flag being on, and the second condition includes the TA report enable flag being off.

21. The method of claim 18, wherein the first UL grant supports transmission of a larger size message than the second UL grant.

22. A wireless communication method performed by a user equipment, UE, comprising:
transmitting a random access preamble to a network entity, NE;
receiving from the NE, a first random access response, RAR, including a first uplink, UL, grant for a first condition; and
receiving, from the NE, a second RAR, including a second UL grant for a second condition,
wherein the first UL grant is different from the second UL grant, and
wherein the first and second conditions being a terrestrial or non-terrestrial type of network cell on which the NE receives the random access preamble or whether a timing advance, TA, report flag is enabled.

23. The method of claim 22, wherein the first condition includes a random access preamble being transmitted by the UE via a non-terrestrial network, NTN, cell, and the second condition includes the random access preamble being transmitted by the UE via a terrestrial network, TN, cell.

24. The method of claim 22, wherein the first condition includes a TA report enable flag being on, and the second condition includes the TA report enable flag being off.

25. The method of claim 22, wherein the first UL grant supports transmission of a larger size message than the second UL grant.

26. A network entity comprising:
a transceiver configured to exchange messages with a user equipment, UE; and
a processor configured to control the transceiver to,
receive a random access preamble from the UE;
transmit a first random access response, RAR, including a first uplink, UL, grant to the UE for a first condition; and
transmit a second RAR, including a second UL grant to the UE for a second condition,
wherein the first UL grant is different from the second UL grant, and
wherein the first and second conditions being a terrestrial or non-terrestrial type of network cell on which the network entity device receives the random access preamble or whether a timing advance, TA, report flag is enabled.

27. The network entity of claim 26, wherein the first condition includes a random access preamble being transmitted by the UE via a non-terrestrial network, NTN, cell, and the second condition includes the random access preamble being transmitted by the UE via a terrestrial network, TN, cell.

28. The network entity of claim 26, wherein the first condition includes a TA report enable flag being on, and the second condition includes the TA report enable flag being off.

29. The network entity of claim 26, wherein the first UL grant supports transmission of a larger size message than the second UL grant.
